(19) United States
(12) Patent Application Publication
(10) Pub. No.: US 2017/0108134 A1
(43) Pub. Date: Apr. 20, 2017

(54) Medical Gas Manifold

(71) Applicant: BeaconMedaes LLC, Rock Hill, SC (US)

(72) Inventor: Timothy Brian Conner, Gastonia, NC (US)

(73) Assignee: BeaconMedaes LLC, Rock Hill, SC (US)

(21) Appl. No.: 15/393,778

(22) Filed: Dec. 29, 2016

Related U.S. Application Data
(62) Division of application No. 14/327,861, filed on Jul. 10, 2014.
Application No. 14/327,861 is a continuation of application No. 14/066,174, filed on Oct. 29, 2013, now abandoned.
(60) Provisional application No. 61/875,227, filed on Sep. 9, 2013.

(51) Int. Cl. F16K 27/00; G05D 16/16

(52) U.S. Cl. CPC F16K 27/003; G05D 16/166

(57) ABSTRACT

A gas pressure regulator is disclosed that includes a reciprocating piston that engages and disengages from a seat to open the higher pressure and lower pressure sides of the regulator to one another. The regulator includes an elastomer seal between the seat and the piston that has an ignition rating sufficient to avoid combustion in the presence of oxygen at pressure differentials that are a factor of between 5 and 10 between the higher pressure and lower pressure sides of the regulator.

### RELATED APPLICATIONS

This is a divisional of Ser. No. 14/327,861 filed Jul. 10, 2014 for “Medical Gas Manifold.” Ser. No. 14/327,861 is a continuation of Ser. No. 14/066,174 filed Oct. 29, 2013 for “Medical Gas Manifold.”

### BACKGROUND

The present invention relates to the safe and proper handling of gases in the medical (e.g., hospital) environment.

A number of gases are used in the hospital environment, both for patient care and for other various purposes.

Oxygen is typically supplied for patients who require supplemental oxygen as part of their care. Nitrous oxide (N₂O) has anesthetic properties and is typically supplied to operating rooms (surgical suites) for preoperative and operative procedures. Nitrogen is typically used to power mechanical items such as surgical equipment. Carbon dioxide is typically used to handle (e.g., inflate or suspend) tissue during surgery and also in some types of laser surgery. “Medical air” is typically used for patient inhalation via ventilators or for breathing treatment. “Instrument air” is another term for compressed air, typically used to drive mechanical tools. Additionally, mixtures of these gases and other gases, as well as vacuum capabilities, are typically part of the hospital environment.

In typical medical or hospital applications, oxygen is best delivered for end use at pressures of around 55 pounds per square inch (psi), nitrous oxide at about 50 psi, nitrogen at about 175 psi, carbon dioxide at about 50 psi, medical air at about 55 psi, and instrument air at about 175 psi.

The amounts of such gases used in a hospital tend to be rather large. Thus, in accordance with the ideal gas law (or its more sophisticated versions), the volume required to store gases at room temperature and typical delivery pressures also would be very large. Because of that, and as is the case in other gas-delivery circumstances, hospital gases are typically stored in groups (“banks”) of either high-pressure cylinders (e.g,. at pressures up to about 2500 psi) or cryogenic tanks (oxygen and nitrogen) and then delivered at the lower end use pressures using appropriate regulators and associated hardware.

Because of the hospital environment, such regulators and related delivery hardware must meet stringent requirements that are not typical elsewhere; i.e., the hospital context is unique in a number of circumstances. Relevant best practices are well understood and have become codified in various regulations. These include (but are not limited to) the NFPA regulations in United States (e.g. 38 CFR 51.200), the CSA regulations in Canada, and the ISO regulations in Europe.

The combinations of different gas sources, different pressures at both the source and delivery positions, and the various regulations applicable to the hospital or medical environment, all create complications that must be addressed in the gas delivery system.

As used herein, the term “regulator” refers to a mechanical device that controllably reduces the pressure of an incoming gas and delivers it for use at a specified lower pressure (or pressure range). Accordingly, in the hospital environment regulators must transfer gas from high-pressure cylinders (up to 2500 psi) to the intended pressures just described, or from cryogenic cylinders. Although cryogenic cylinders store gas as a liquid, they still contain internal gas pressures of about 300 psi.

One of the requirements for the gas delivery system—particularly in hospitals—is redundancy; i.e., the gas supply cannot be interrupted under any normal circumstances (e.g., repair or resupply) or even in many abnormal circumstances. Because of that, hospitals typically have at least a primary source of gases (the “primary side”) and a complementary back up set of gases referred to as the “secondary side.” In turn, the hospital gas delivery system must likewise include primary side regulators and other delivery equipment and separate secondary side regulators and delivery equipment. In best practices, the flow of each and every gas will continue without interruption if one side is shut off. The most typical circumstance is to transfer from the primary side to the secondary side so that the primary side tanks can be replaced with full ones when empty. Additionally, other circumstances (both typical and unforeseen) can also create interruptions and the gas regular system must be able to handle such events without allowing interruptions in the gas flow.

Conventionally, the required equipment and redundancy is built from existing (“off-the-shelf”) components. Although such readily available parts can superficially lower initial costs, such conventional equipment (e.g., regulators, valves, fittings) can suffer from certain disadvantages.

As one disadvantage, certain polymer rubbers (elastomers) have properties that make them incompatible with certain hospital gases. Generally, some elastomers are compatible with oxygen, but not nitrous oxide or carbon dioxide (and vice versa). As an example, some halogenated elastomers give off toxic fumes when ignited.

In particular, the (potentially) large pressure changes within regulators (e.g., from 2500 psi in a bank to 250 psi in a manifold) can produce adiabatic compression that significantly elevates the gas temperature. When the gas is oxygen in the presence of hydrocarbon-based elastomers (e.g., sealing O-rings and related parts), combustion can-and does-result. In particular, hydrocarbon rubbers such as polyurethane, styrene butadiene, polyisoprene and ethylene-propylene-diene ignite easily, and have high fuel value and heat release.

Halogenated elastomers such as Viton® can favorably withstand higher temperatures than such other elastomers. For example, Viton® has a rated combustion temperature of about 400° F., while nitrile butyl rubbers are on the order of 212° F. Nevertheless, when halogenated elastomers burn, they tend to detrimentally release halogen gases and gas compounds.

Some such halogenated elastomers tend to absorb carbon dioxide and nitrous oxide and then disperse such absorbed gases rapidly under a relatively large pressure release, such as those experienced in high-pressure-to-low pressure regulators. In turn, such release tends to physically harm (i.e., blister or blow out) the elastomer piece and thus destroy its function, and in turn the function of the entire regulator. Some non-halogenated polymers avoid the absorption problems, but (as noted previously) suffer from a tendency to ignite in the presence of oxygen undergoing adiabatic compression.

As a result, in conventional regulators and structures incorporating regulators, some or all of the typical polymer fittings (e.g., o-rings, diaphragms, etc.) must be selected based upon the gas being used even though the equipment being fitted is otherwise identical in most or all respects. In a sense, this bases the polymer choice on potential disadvantages rather than on potential advantages. Such fittings can reduce efficiency and thus increase overall cost, for both manufacture and use (maintenance). In some cases, different regulators with different elastomers are used for the different gases, but at higher cost and lower efficiency.

As a separate and distinct problem, the regulators used in hospitals, along with their associated valves, gauges and fittings need to stay structurally intact under pressure, and a user (e.g., maintenance worker) should not be able to remove items from the regulator structure while the pieces are pressurized. This is a safety issue.

As a third distinct issue, the piston assemblies used in conventional regulators can permit larger than desired drops in pressure during flow. The elastomer diaphragms used in conventional regulators tend to have more “droop.” More specifically, pressure regulation is a function of inlet pressure. As the inlet pressure source is reduced, regulator delivery pressure may either rise or fall depending upon the regulator design. In both cases this is known as regulator “droop.” The side loading design of many regulator piston assemblies tends to increase both the friction and the droop of the assembly. Additionally, balancing the piston assembly on the line regulator also tends to increase friction and droop.

As another independent problem, regulators must be serviced from time to time and are typically mounted on a wall. The nature of much conventional regulator construction, however, makes it very difficult to operate or repair a regulator while it is in position on the wall (“vertical”). Typically the regulator and a number of associated parts must be removed from the wall or it's housing, serviced, and then returned. This series of steps decreases efficiency, takes extra time, and thus increases the cost of use.

Finally, in many conventional hospital gas delivery systems the user must review the manifold directly in order to understand the status (pressure and flow) of the various gases. Therefore, unless a person is constantly viewing or frequently inspecting the relevant gauges (or other output), real-time information will be delayed or in some cases missed altogether.

### SUMMARY

In one aspect, the invention is a gas pressure regulator that includes a reciprocating piston assembly that engages and disengages from a seat to open the higher pressure and lower pressure sides of the regulator to one another. The regulator includes an elastomer seal between the seat and the piston assembly that has an ignition rating sufficient to avoid combustion in the presence of oxygen at pressure differentials that are a factor of between 5 and 10 between the higher pressure and lower pressure sides of the regulator.

In a second aspect, the invention is a gas pressure manifold that is particularly suitable for medical industry applications. In this aspect, the invention includes at least one pair of bank regulator bodies for supporting regulators that moderate the flow of high-pressure gas from a gas source while providing redundancy for continuous gas flow through at least one regulator at all times, at least one pair of line regulator bodies for holding line regulators in gas communication with the bank regulators, and with the bank regulator bodies and the line regulator bodies being joined by at least one brace bar for preventing the brace bar from being removed when the forgings are under pressure.

In another aspect, the invention is a gas pressure regulator that includes a regulator body, a piston assembly in the regulator body, a spring chamber, a spring in the spring chamber, and a cup shaped piston diagram in the spring chamber and surrounding the portions of the spring adjacent the piston valve for eliminating or minimizing the flexing of various materials under pressure in the regulator.

In another aspect, the invention is a medical gas alarm system for use in a healthcare facility having medical gas systems which severally deliver a plurality of medical gases to a plurality of locations in the healthcare facility and having a network of computer devices. In this aspect, the invention includes a gas pressure manifold included in the network of computer devices in which the gas pressure manifold includes bank regulators, line regulators, and pressure sensors associated with each regulator, and network connectors between the sensors and the remainder of the network for remote monitoring of cylinder pressure levels, alarm status, event logs, and similar items from any computer on the network.

The foregoing and other objects and advantages of the invention and the manner in which the same are accomplished will become clearer based on the followed detailed description taken in conjunction with the accompanying drawings.

### BRIEF DESCRIPTION OF THE DRAWINGS

FIG. 1 is a perspective view of the manifold external housing.

FIG. 2 is a perspective view of the manifold with the housing removed.

FIG. 3 is a front elevational view of the manifold and the control box.

FIG. 4 is a front elevational view of a second embodiment of the manifold and control box.

FIG. 5 is a front elevational view of the forging portion of the manifold.

FIG. 6 is a side elevational view of the forging of FIG. 5.

FIG. 7 is an exploded perspective view of one of the line regulators in the context of the manifold.

FIG. 8 is a perspective exploded view of one of the bank regulators in the context of the manifold.

FIG. 9 is a cross-sectional view of a bank regulator.

FIG. 10 is a cross-sectional view of a line regulator.

FIG. 11 is a schematic diagram of a network that includes the manifold.

FIG. 12 is a perspective view of a single forging according to the invention.

FIG. 13 is a rear perspective view of a manifold according to the invention.

FIG. 14 is an exploded perspective view of the inlet and inlet filter according to the invention.

### DETAILED DESCRIPTION

The terms “hospital” and “medical” are used in a descriptive rather than limiting context in this specification, and the invention's advantages apply in the general context regardless of whether or not the particular environment is a hospital per se.

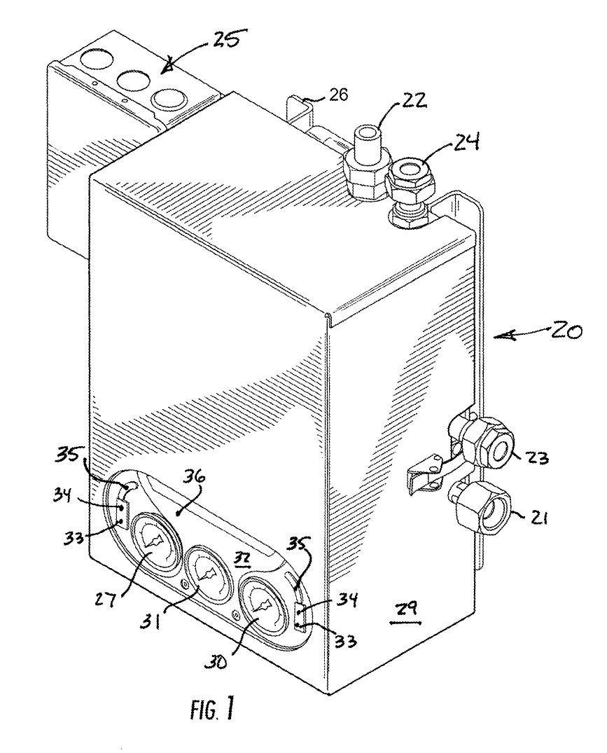

FIG. 1 is a perspective view of the medical gas manifold of the invention inside of a housing broadly designated at 20. In typical embodiments, the housing is formed of an appropriate sheet-metal, the nature of which should be consistent with the local environment and medical applications, but that otherwise can be selected by those of ordinary skill in the art without undue experimentation.

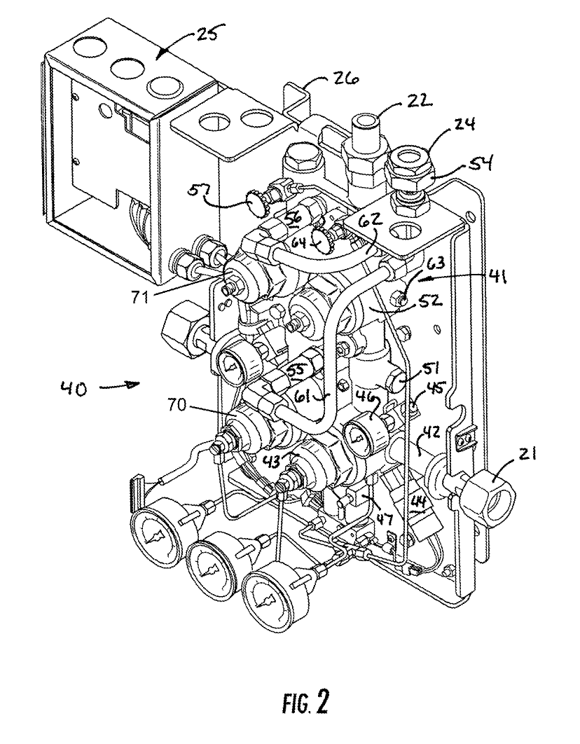

The manifold includes an inlet fitting 21 and an outlet fitting 22. A reserve header inlet 23 is positioned adjacent the inlet 21, and a relief valve fitting 24 is adjacent the outlet fitting 22. In exemplary embodiments, the inlet portion of the bank regulator (43, 70; FIG. 2) also includes a gas-inlet filter (FIG. 14) which is formed of a shaped portion of sintered bronze, a material that has improved heat retention, acts as a flame arrestor, has better particle retention, and slows gas velocity better than some other materials.

A control box broadly designated at 25 is positioned adjacent the housing 29 and can be mounted on the same back panel 26 as the main portions of the manifold.

To assist in use, the manifold includes a left bank pressure gauge 27, a right bank pressure gauge 30 and a delivery pressure gauge 31. These are mounted in (or flush with) a face plate 32 which includes a plurality of light emitting diode (LED) indicators.

Each respective bank has an empty signal LED 33, a ready signal LED 34 and an in use signal LED 35. A changeover LED 36 indicates when the manifold is switching between banks. The forging 41 helps to (among other advantages) eliminate the leaks to which conventional separate items are more susceptible.

FIG. 2 is a perspective view of the manifold broadly designated at 40 with the housing 29 removed. The manifold is formed from one or more forgings which are broadly designated at 41. The forging in an isolated context is perhaps best illustrated in FIGS. 5, 6 and 12.

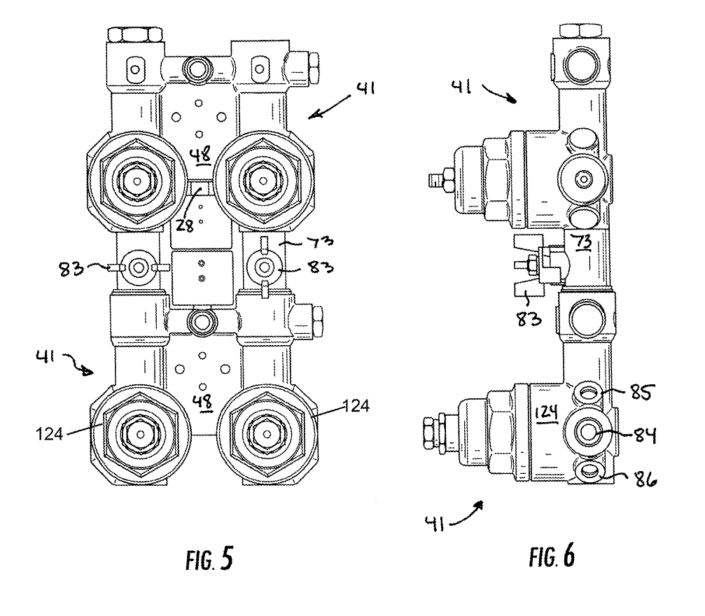

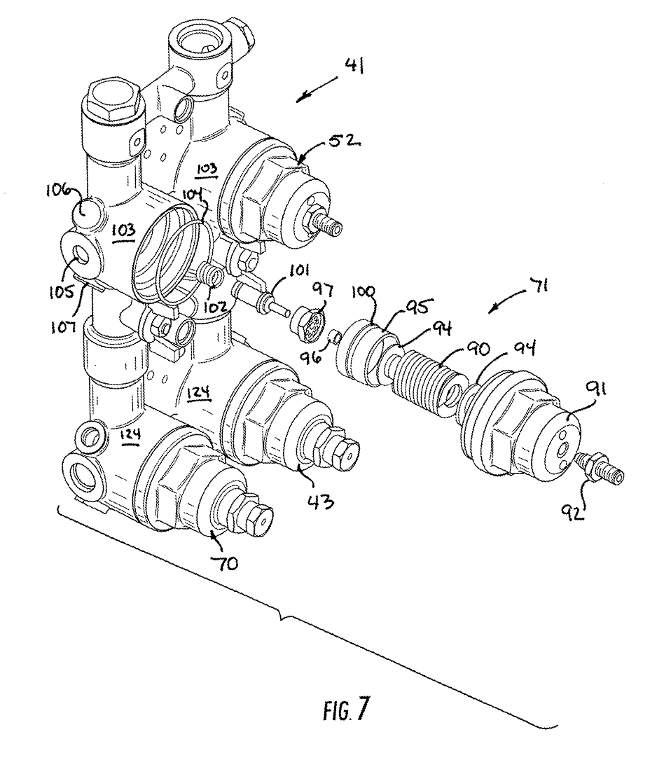

The manifold 40 includes at least one pair of bank regulator bodies 124 (e.g., FIGS. 6 and 7) for supporting bank regulators 43, 70 that moderate the flow of high-pressure gas from a gas source while providing redundancy for continuous gas flow through at least one of the bank regulators at all times. At least one pair of line regulator bodies 103 hold line regulators 52, 71 in gas communication with the bank regulators 43, 70.

The bank regulator bodies and the line regulator bodies are joined by at least one brace bar 28 so that the relationship prevents the brace bar from being removed when the forgings are under pressure.

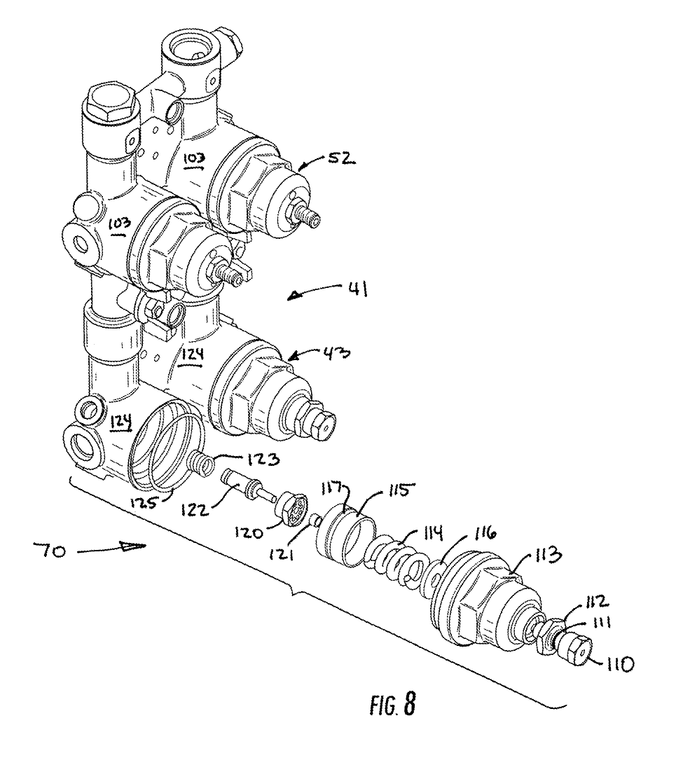

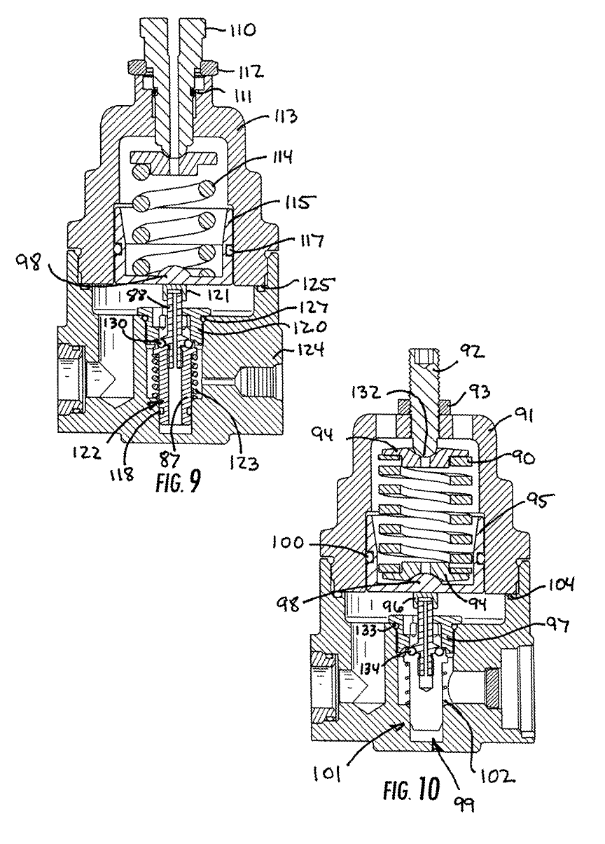

Some features of the manifold, it's structure, and its operations can be identified by following the flow of gas in the illustrated embodiments. Thus, gas from a bank (of tanks or cryogenic cylinders) enters the manifold through the inlet fitting 21 and the inlet pipe 42, from which it reaches the right (or “primary”) side bank regulator 43. More detailed views of the bank regulator 43 are set forth in FIGS. 8 and 9. Those skilled in the art understand, of course, that “primary” and “secondary” refer to the mode of use rather than to any absolute right or left orientation.

A pressure switch 44 is connected to the right bank regulator 43 along with a bleed valve 45 and a bank pressure gauge 46. A solenoid valve 47 and (optionally) a dome pressure regulator (not illustrated in this embodiment) help control the operation of the bank regulator 43 through the various piping connections which, for purposes of clarity, are not all individually labeled. Their structure and function are nevertheless both typical and well understood by the skilled person.

The vertical portion of the forging 41 that extends outwardly from the bank regulator 43 includes a check valve (not shown in FIG. 2) as well as the reserve header port 51.

As generally well understood by the skilled person and as explained in the Background, the purpose of the bank regulator 43 is to reduce the high pressure of the gas received from the bank tanks or cryogenic cylinders to an intermediate pressure which is more suitable for the more detailed control provided by the line regulators.

Accordingly, FIG. 2 likewise illustrates a right (primary) line regulator 52 which is likewise fixed in a portion of the forging 41. The right line regulator 52 delivers gas at the desired pressure through the outlet 22 which is illustrated in the context of a zero clearance fitting 53. A similar zero clearance fitting 54 is on the relief valve outlet 24.

FIG. 2 also illustrates an intermediate relief valve 55, a line relief valve 56, a vent valve 57, and a service valve 64. The intermediate relief valve 55 is connected to the overall relief valve 24 through a tube 61 and the line relief valve 56 is likewise connected to this destination by the tube 62. In FIG. 2 the tubes 61 and 62, along with the smaller tubes which are unnumbered for clarity purposes, are formed of rigid copper tubing. This is in accordance with ISO standards. Depending upon the regulatory overlay in the country or jurisdiction of use, some or all of the tubing can be formed of an appropriate flexible polymer material provided it is otherwise consistent with the physical, chemical, safety, and other relevant requirements.

FIG. 2 also illustrates a service bleed valve 63 and a knobbed service valve 64.

FIG. 2 also illustrates a plurality of pipe fittings, connectors, elbows, and the like each of which is generally well understood both in terms of their general structure and function and their structure and function in the context of the manifold of the invention.

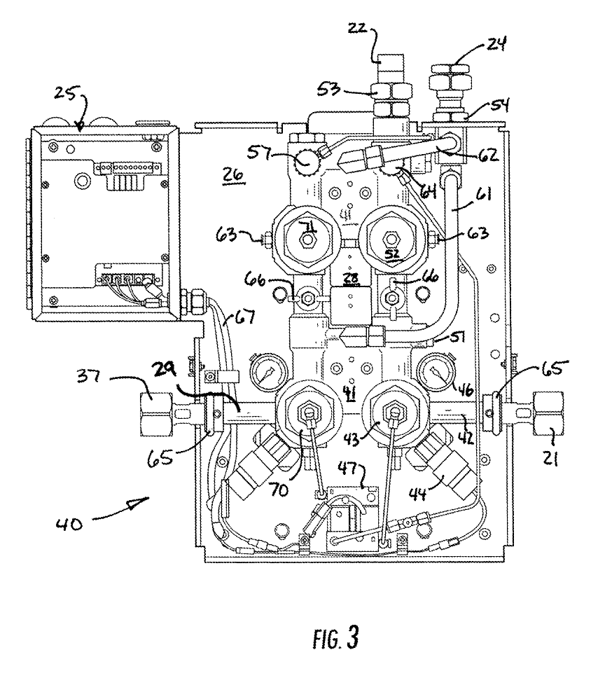

FIG. 3 illustrates all of the items in FIG. 2, as well as several that are clearer in the front elevational view.

Some of these items include the respective locking collars 65 on the inlet pipes 42 (and the corresponding secondary inlet pipe 29) and respective isolation (ball) valves 66 located in the forging 41 between each respective bank regulator 43 and line regulator 52. It will be generally understood, of course, that where identical items are shown in parallel with one another, they are the same item and serve the same purpose, with the only difference being that one set serves a gas bank or cylinders entering the manifold from the left and the other serves the gas bank or cylinders entering the manifold from the right. For example, an inlet fitting 37 corresponds to the secondary inlet in the same manner as the inlet fitting 21 corresponds to the primary inlet.

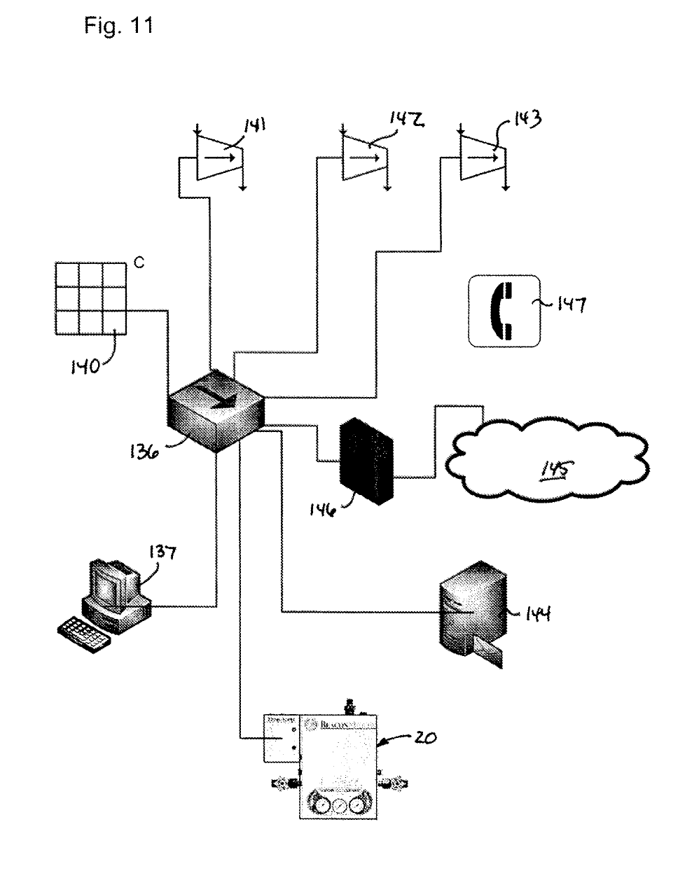

FIG. 3 also illustrates that a plurality of electrical wires and cables help control various items. Many of these pass through the cable covers 67 illustrated on the left-hand side of FIG. 3 from which they enter the control box 25. The nature of the electrical controls is generally otherwise conventional and well understood by those of skill in this art. As set forth with respect to FIG. 11, these controls also help connect the manifold to a hospital computer network (or its equivalent).

In some embodiments the manifold can include a dome pressure regulator which can be connected to the solenoid valve and the bank regulators. Although positioning is a matter of design choice, in the illustrated embodiments, when a dome pressure regulator is included, it can be positioned in the lower portions of the housing 20.

Each of the regulators is associated with a respective check valve. The check valves are maintained in the portion of the forging extending vertically above each respective bank or line regulator. For the sake of completeness, the left (secondary) bank regulator is labeled at 70 and the left (secondary) line regulator at 71.

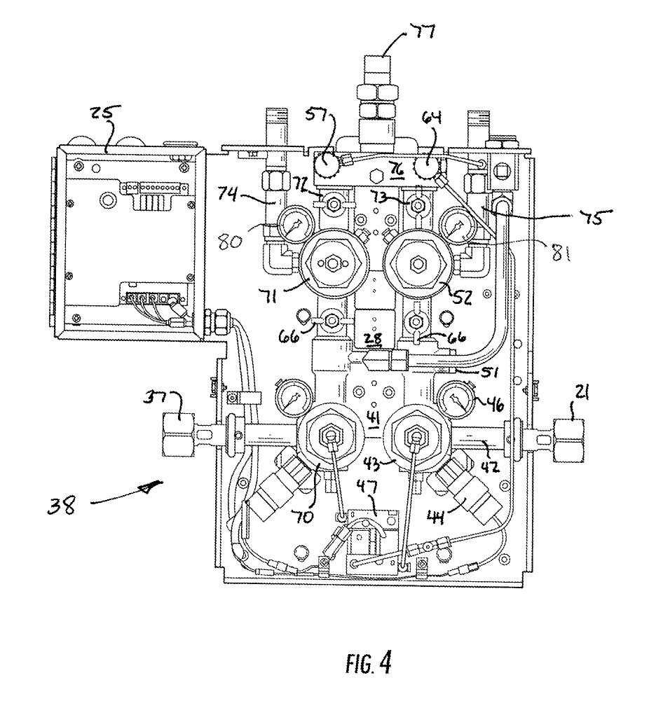

FIG. 4 is a front elevational of view of a second embodiment of the invention broadly designated at 38 which meets the Canadian (i.e., CSA) design and regulatory criteria. Much of the regulator is generally the same as described with respect to FIG. 3, but under CSA standards, a check valve cannot be positioned between the line regulator and the outlet.

Accordingly, in this embodiment the line regulators 71 and 52 are connected to isolation valves 72 and 73 respectively. Pressure relief valves 74 and 75 are also connected to the regulators 71 and 52. The isolation valves 72 and 73 are connected to a sub-manifold 76 which provides the functional connection to the vent valve 57 and the service valve 64, as well as a common outlet 77. This embodiment also includes line regulator pressure gauges 80 and 81 respectively.

The remaining items in FIG. 4 are the same structurally and functionally as in FIG. 3 and carry the same reference numerals.

FIGS. 5 and 6 illustrate the forging 41 somewhat more clearly in partial isolation from a number of the items in FIGS. 1-4. A number of the items are, of course, the same as in FIGS. 1-4 and thus carry the same reference numerals. In particular, FIGS. 5-8 show two forgings 41 stacked on top of one another and connected by the brace bar 28 and with the intermediate isolation valves 73.

In the manifold of the invention the bank regulator bodies 124 are part of a common forging 41 and the line regulators are part of a common forging 41, and the brace bar 28 is fixed to each of the common forgings. In the illustrated embodiment, the brace bar 28 is shown having several rectangular plate portions, but it will be understood that this configuration is exemplary of the possibilities rather than limiting.

In turn, the common forgings 41 comprise respective metal bridging webs 48 between the bank regulator bodies and the line regulator bodies, and the brace bar 28 is fixed to each of the respective metal bridging webs.

In exemplary embodiments, the regulator bodies and the brace bar 28 are formed of metal.

In the CSA version illustrated in FIG. 4, the bank regulator bodies are formed in a common forging, but the line regulator bodies are separate. Thus, the brace 28 bar is fixed to the common bank regulator forging and then individually to the line regulator bodies 103.

Some of the items that are more clearly illustrated include, however, the handles 83 on the isolation valves 73. FIGS. 5 and 6 also more clearly illustrate the respective inlet for the gas 84, the pressure gauge 85 and the switch 86.

FIG. 7 is an exploded view of the left line regulator 71 and FIG. 10 is a corresponding cross-sectional view. FIG. 7 illustrates the regulator spring 90 which is received in the spring chamber 91 and bears against a cup-shaped piston diaphragm 95. The piston diaphragm 95 surrounds portions of the spring 90 adjacent the piston assembly 101 and its seat 97 and helps minimize or eliminate the oblique flexing that the spring 90 would otherwise undergo (or exert) under pressure. The spring pressure (and thus the regulator's set pressure) can be adjusted using the adjustment screw 92 and it's locknut 93. Respective spring buttons 94 are positioned at the top and bottom of the spring 90. In exemplary embodiments the bank regulator spring 114 is formed of stainless steel, because it has a higher threshold temperature for promoted combustion than some other typical spring metals.

As noted previously, upper and lower spring buttons 94 are positioned at opposite ends of the spring 90, and each of the spring buttons includes a gimbal-type indentation (e.g., FIGS. 9 and 10). The adjustment screw 92 includes a well-rounded nose 132 (FIG. 10) that engages the gimbal on the upper spring button, and a rounded projecting floor portion 97 on the cylindrical piston diaphragm 95 engages the lower spring gimbal. These parts cooperate to mitigate the effect of varying spring squareness and help direct the regulator forces linearly rather than obliquely. In turn, these items keep the regulator parts aligned during operation, which increases the regulator's accuracy and precision, and reduces its droop. The cup shape of the piston diaphragm 95 also captures the spring and spring buttons in a manner that allows the regulator parts to be removed from the regulator bodies while the regulator bodies remain fixed with the remainder of the manifold. From a practical standpoint, this means that the regulator parts can be removed and serviced (or replaced) while the remainder of the manifold remains in its in-use location and position (which is often a vertical orientation). In contrast, the multiple parts of a conventional regulator tend to separate quickly (and disadvantageously) unless the entire regulator—and in some cases the entire manifold—is removed from its in-use position and then serviced elsewhere.

The piston diaphragm of the invention is illustrated at 95, and in exemplary embodiments is formed of brass. As FIG. 7 illustrates, the spring 90 and its buttons 94 are positioned between the piston diaphragm 95 and the spring chamber 91. A pusher post button 96 is beneath and bears against the piston diagram 95 on one side and the seat ring 97 with an O-ring (too small to be clear in this illustration) on the other side. The piston diaphragm 95 carries an O-ring 100 around its circumference generally about halfway between the top and the bottom of the diaphragm 95. A piston assembly 101 is beneath and bears against the seat ring 97 and is surrounded by the seat spring 102, which closes the seat. The spring chamber 91 threads into the regulator body 103 and a body O-ring 104 helps create and preserve a seal against leakage in the overall regulator structure.

As illustrated in both FIG. 7 and FIG. 10, the piston assembly 101 is free to reciprocate in its piston chamber 99 without the conventional sealing O-ring that typically surrounds such a piston in a regulator (e.g., the O-ring 118 in the bank regulator). Avoiding the O-ring helps the piston move more smoothly, which in turn reduces the droop.

In exemplary embodiments, and as set forth with respect to FIG. 10, an HNBR elastomer is incorporated in the piston assembly 101 to provide a higher temperature rating.

FIG. 7 also illustrates that in a manner analogous to the openings in the bank regulators (e.g., FIG. 6), the regulator body 103 includes a bleed valve opening 105, a pressure gauge port 106, and (if desired) a pressure switch port 107.

The remaining items in FIG. 7 are the same as shown in and described with respect to FIGS. 1-6 and will not be repeated here.

FIG. 8 is an exploded view similar to FIG. 7, but illustrating the left bank regulator 70 in the exploded view. FIG. 8 illustrates an adjustment screw 110 that carries an O-ring 111 and a locknut 112. The spring chamber is illustrated at 113 and the spring at 114. The spring rests between the piston diaphragm 115 (which again includes an O-ring 117) and a spring button 116.

A seat ring 120 is beneath piston diagram 115 with a pusher post button 121 in between. The seat ring 120 carries an O-ring (not shown in FIG. 8). The seat ring can be formed of monel alloys (i.e., specialized nickel-copper alloys), brass, or stainless steel. The piston assembly is illustrated at 122 and rests in a seat spring 123. The seat spring 123 is preferably formed of austenitic nickel-chromium based “superalloy” (e.g., Inconel 750) or of a copper beryllium alloy. In turn, these parts rest in the regulator body 124 with pressure being maintained in place by the O-ring 125. The remaining elements in FIG. 8 are either the same as those described and illustrated in the exploded portion, or in the preceding drawings.

FIG. 9 is a cross-sectional view of the bank regulator 70 of FIG. 8 and FIG. 10 is a cross-sectional view of the line regulator of FIG. 7.

Most of the elements illustrated in FIGS. 9 and 10 have already been described, but FIGS. 9 and 10 include some additional details. FIGS. 9 and 10 illustrate the regulators in their open positions.

FIG. 9 illustrates more details of the piston assembly 122 in a line regulator. In the illustrated embodiment, the piston assembly includes a piston base 87, a piston stem 88 and the O-ring 130 between the base 87 and the stem 88. An O-ring 127 is on the seat ring 120, and the O-ring 130 is between the piston assembly and the seat 120. An O-ring 118 is positioned at the bottom of the piston assembly 122.

In particular, the seat O-ring 130 functions as the seal between the high pressure (e.g., 2500 psi) and lower pressure (e.g., 250 psi) portions of the regulator. Because of that, in the invention the O-ring 130 is formed of an elastomer that can withstand adiabatic compression of a factor of at least 5, and preferably 10 (pressure to pressure) without igniting in oxygen. Certain rigid engineering polymers meet this requirement, but are not sufficiently flexible for the regulator's purpose. Various combinations of polysilphenylene-siloxane and polyphosphagene have high temperature combustion rations, but a highly favorable choice appears to the hydrogenated nitrile butyl rubber (“HNBR”).

HNBR has good viscoelastic properties, a service temperature range of between about −40° C. to +150° C. (−40 to 300 F.), resistance to fluids of various chemical compositions and excellent resistance to strongly alkaline and aggressive fluids. HNBR is a derivative of nitrile rubber, which is hydrogenated in solution using precious metal catalysts. Different grades can be made by precise control of the proportion of unconverted double bonds in the material. HNBR is resistant to thermo-oxidative aging, with typical service life ratings that correspond to a long-term exposure of 1000 hours at 150° C. (about 300 F.).

FIG. 10 shows some additional details about the line regulator. These include the rounded nose 132 on the adjustment screw 92. FIG. 10 also shows the O-ring 133 on the seat ring 97 as well as the O-ring 134 in the piston assembly 101.

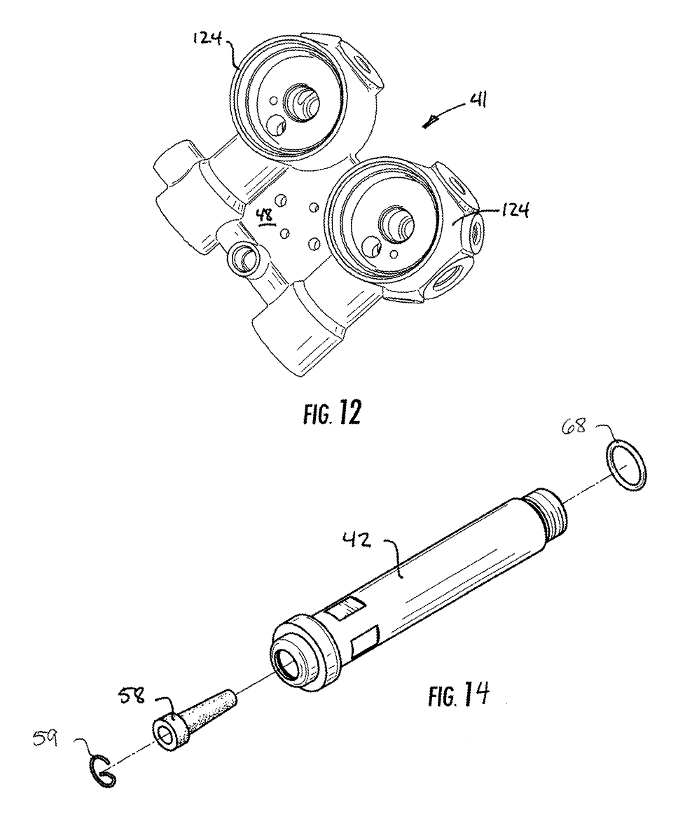

FIG. 12 is a perspective view of a single forging 41 and illustrated the regulator bodies 124 and the metal bridging web 48.

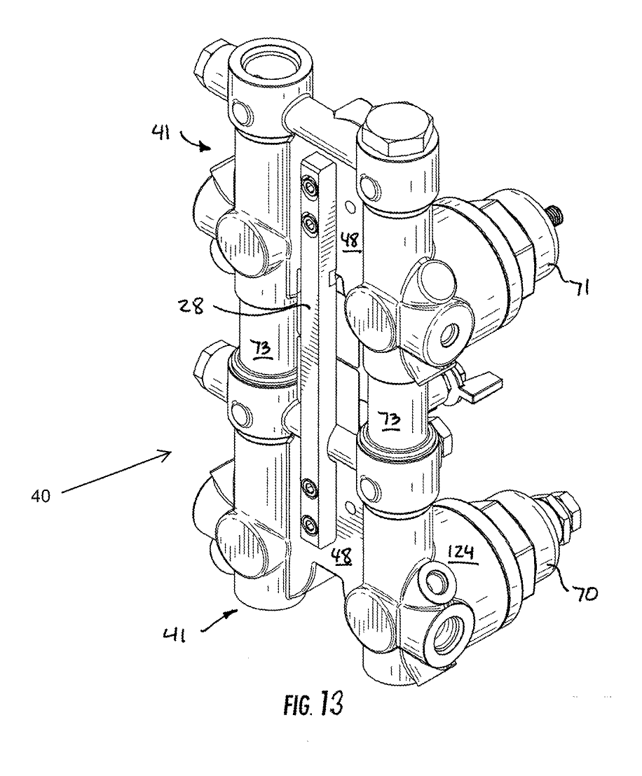

FIG. 13 is a perspective view of the manifold 40 that illustrates the manner in which the brace bar 28 connects two forgings 41 together.

FIG. 14 is an exploded perspective view of the inlet pipe 42 illustrating the sintered bronze filter 58. The filter 58 has a body that includes a longitudinally-projecting portion that has a frustum shape in the illustrated embodiment. In exemplary embodiments, the filter 58 is formed of sintered bronze with a 40 micron size. The volume and shape of the filter 58 helps slow gas velocity, improve heat rejection, and retain particles more efficiently than simpler shapes. FIG. 14 also illustrates a retaining ring 59 for the filter 58 and an O-ring 68 for the inlet pipe 42.

FIG. 11 illustrates the use of the manifold in connection with network capability for a medical air system. This is consistent with the TOTALALERT™ system from Atlas Copco/BeaconMedaes (Rock Hill, S.C.). This aspect off the invention is also consistent with the systems described in U.S. Pat. Nos. 7,768,414; 7,145,467; and 6,987,448, the contents of which are incorporated entirely herein by reference.

An exemplary embodiment is a medical gas alarm system for use in a healthcare facility having a medical gas system which delivers a plurality of medical gases to a plurality of locations in the healthcare facility and having a network of computer devices. In this context, the invention includes a gas pressure manifold that communicates with the network of computer devices. As already described, the gas pressure manifold includes bank regulators, line regulators, and pressure sensors associated with each regulator. Network connectors between the sensors and the remainder of the network permit remote monitoring of cylinder pressure levels, alarm status, event logs, and similar items, using any computer on the network. The system likewise typically includes a network hub (or equivalent), an Internet connection (with firewall), and an email server.

In most cases, the medical gas system includes vacuum pumps and medical air pumps that are also in communication with the network. In exemplary embodiments, any and all alarm devices in the system communicate with the network.

FIG. 11 illustrates that the manifold (illustrated in its housing 20) can be networked to an appropriate Ethernet hub 136. The hub 136 (or its equivalent) is in turn connected to a computer 137 with web browsing capability or to any equivalent device such as a tablet or smart phone. An alarm 140 is connected to the network as are other portions of the medical air system. These are symbolically illustrated at 141, 142, and 143 in the drawings, and can represent various aspects of the medical air system, such as the medical air supply 141, a crawl-type vacuum 142, or a lubricated rotary vane vacuum 143.

An email server 144 is connected to the network and can communicate internally through the hub 36 or with the Internet 145, with a firewall 146 typically being included for security purposes. The email server can generate messages that, using the Internet, can be directed to one or more cellular phones 147 or their equivalent; i.e. the term “cellular phone” is used in a broad sense to incorporate devices that can receive text messages, email, or other communications, including but not limited to smart phones and tablet computers. Additionally, such messages can be received by more conventional computers (“PC'”s or “laptops”) that have either Wi-Fi or cellular capability or both depending upon context.

The TOTALALERT™ network monitors medical air, medical vacuum, medical master alarm, medical area alarms, and now the medical manifold of the invention. No additional software is required and the equipment on the network reside as IP points on the user's intranet. One key feature of the TOTALALERT™ network is that a single web page displays all of the equipment on the network. Although other systems may add embedded software to a product, none appear to include a centralized web page from which all of the individual components can be monitored.

In the drawings and specification there has been set forth a preferred embodiment of the invention, and although specific terms have been employed, they are used in a generic and descriptive sense only and not for purposes of limitation, the scope of the invention being defined in the claims.

1. A gas pressure manifold that is particularly suitable for medical industry applications, said manifold comprising:
at least one pair of bank regulator bodies for supporting regulators that moderate the flow of high-pressure gas from a gas source while providing redundancy for continuous gas flow through at least one regulator at all times;
at least one pair of line regulator bodies for holding line regulators in gas communication with bank regulators; and
said bank regulator bodies and said line regulator bodies being joined by at least one brace bar.

2. A manifold according to claim 1 wherein said bank regulator bodies are part of a first common forging and said line regulators are part of a second common forging, and said brace bar is fixed to each of said first and second forgings.

3. A manifold according to claim 2 wherein said common forgings comprise respective metal bridging webs between said bank regulator bodies and said line regulator bodies, and said brace bar is fixed to each of said respective metal bridging webs.

4. A manifold according to claim 2 wherein said regulator bodies and said brace bar are formed of metal.

5. A gas pressure manifold according to claim 1 further comprising a bank regulator in each said bank regulator body and a line regulator in each said line regulator body

6. A gas pressure manifold according to claim 1 wherein:
said bank regulator bodies are formed in a common forging;
said line regulator bodies are separate; and
said brace bar is fixed to said common bank regulator forging and then individually to said line regulator bodies.

7. A gas pressure manifold according to claim 6 wherein said common forging for said bank regulator bodies includes a metal bridging web, and said brace bar is attached to said metal bridging web and individually to each said line regulator body.

8. A gas pressure manifold according to claim 5 in which each said regulator includes a regulator body; a piston assembly with a piston in the regulator body; a spring chamber; a spring in the spring chamber; a cup shaped piston diagram in the spring chamber and surrounding the portions of the spring adjacent the piston assembly; and a seat with an elastomer seal between the piston and the seat.

9. A gas pressure manifold according to claim 8 in which said elastomer seal that has an ignition rating sufficient to avoid combustion in the presence of oxygen at pressure differential that are a factor of between 5 and 10 between said higher pressure and lower pressure sides of said regulator.

10. A gas pressure manifold according to claim 9 wherein said elastomer seal avoids combustion at temperatures of between about 250° and 450° F. under adiabatic compression of oxygen.

11. A gas pressure manifold according to claim 9 wherein said elastomer seal comprises hydrogenated nitrile butyl rubber.

12. A gas pressure manifold according to claim 9 wherein said elastomer seal is an O-ring on said piston assembly.
